(19) United States
(12) Patent Application Publication
(10) Pub. No.: US 2026/0262620 A1
(43) Pub. Date: Sep. 10, 2026

(54) MAGNESIUM ALLOY SPOOL AND FISHING REEL COMPRISING THE SPOOL

(71) Applicants: Pure Fishing Japan Co., Ltd, Tokyo (JP); Jia Dun Sports Equipment Co., LTD, Guangzhou (CN)

(72) Inventors: Eigo Urabe, Katsuura (JP); Chi Shing Li, Hong Kong (HK); Guo Hua Zang, Guangzhou (CN); Chao Yong Zhang, Guangxi (CN)

(21) Appl. No.: 18/704,317

(22) PCT Filed: Sep. 26, 2023
(86) PCT No.: PCT/JP2023/034805

§ 371 Date: May 8, 2026

(51) Int. Cl. A01K 89/015

(52) U.S. Cl. CPC A01K 89/015

(57) ABSTRACT

A fishing reel includes a magnesium alloy spool having a coating for imparting corrosion resistance. The fishing reel is capable of precisely controlling a size of a gap between a frame and a spool flange. A coating formed by a micro-arc oxidation (MAO) treatment is formed on a surface of at least a portion including the flange of the spool.

### CROSS REFERENCE

This application claims priority to PCT Application No. PCT/JP2023/034805, filed Sep. 26, 2023, the entirety which is hereby incorporated by reference.

### FIELD OF THE INVENTION

The present invention relates to a magnesium alloy spool and a fishing reel comprising the same, and more particularly relates to a magnesium alloy spool having a coating for preventing corrosion and a fishing reel comprising the same.

### BACKGROUND OF THE INVENTION

Fishing reels include spinning reels, double-bearing reels, and single-bearing reels. In double-bearing reels and single-bearing reels, a spool is rotatably supported by a reel main body, and in spinning reels, a spool is attached to a reel main body so as to be movable back and forth. Spools of these fishing reels are made of synthetic resin, aluminum alloy, magnesium alloy, or the like.

Synthetic resin spools can be manufactured at low cost and can be reduced in weight. However, they have a low flexural modulus, and are required to be made thick in order to maintain rigidity. It is also difficult for them to obtain a good sense of texture and luxury.

Aluminum alloy spools have a larger flexural modulus than synthetic resin ones and give a good sense of texture and luxury. However, they have less flexural modulus during metal ones and are still required to be made thick in order to maintain sufficient rigidity, which limits their weight reduction.

Compared with the spools made of these materials, magnesium alloy spools have greater rigidity and can be thinned, so that their weight can be more reduced. On the other hand, magnesium alloy is easily corroded, and this type of spool thus requires a corrosion-resistant structure.

In magnesium alloy spools, it is common to coat the spools with paint, such as urethane resin-based, paint in order to cope with this problem. However, such a coating has a low surface hardness, and may leave fishing line winding marks on the spool surface.

To address this issue, proposed been has a spool comprising an oxide film layer formed by anodization, a low-hardness base layer formed by cationic electrodeposition paint containing polyamine as the main component, a low-hardness intermediate layer formed by urethane resin-based paint, and a high-hardness surface layer formed by ultraviolet curable paint, in this order, on the surface of a spool main body made of magnesium alloy (see Patent reference JP-A-2000-14288). Such a coating increases hardness of the surface while improving adhesion between the coating and the spool.

### BRIEF SUMMARY OF THE INVENTION

However, spools of fishing reels, particularly of bait casting reels, are required to precisely control their outer diameters, thereby preventing a fishing line from entering the gap between the frame and the spool flange. In this regard, the conventional spool having a multi-layered coating could not address this problem because the thickness of the coating is basically large and it is difficult to precisely control the thickness of the coating.

In view of such a problem, an object of the present invention is to provide a fishing reel comprising a magnesium alloy spool having a coating that imparts corrosion resistance, wherein a thickness of the coating can be precisely controlled, and in turn, a size of the gap between the reel frame and the spool flange can be precisely controlled.

In order to achieve the object, the present inventors have examined various coatings and found that this problem can be solved by forming a coating by a micro-arc oxidation (MAO) treatment, thereby achieving the present invention.

That is, the present invention provides a magnesium alloy spool, the spool comprising a coating formed by a micro-arc oxidation (MAO) treatment on its surface. In a preferred embodiment, the thickness of the coating is 15 to 25 μm, particularly preferably 17 to 23 μm.

The present invention also provides, in another preferred embodiment, a fishing reel comprising a spool as described above. In the preferred embodiment, a gap between the reel frame and the spool flange is 0.05 to 0.25 mm.

A coating formed by a micro-arc oxidation (MAO) treatment is extremely thin and can be precisely controlled in thickness. Thus, the outer diameter of the spool can be precisely controlled, and a gap between the reel frame and the spool flange in size can be precisely controlled to repeatedly form the gap with a size that prevents a fishing line from entering the gap between the frame and the spool flange.

Further, a coating formed by a micro-arc oxidation (MAO) treatment is non-conductive and has high hardness, so that the coating makes a spool highly resistant to corrosion and scratch.

In addition, since the spool is made of a magnesium alloy, the spool can have high rigidity and a thin thickness, which allows the weight of the reel to be more reduced.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 illustrates a fishing reel according to one embodiment of the present invention.

FIG. 2 illustrates a side plate, a reel frame, and a spool assembly of the fishing reel according to the embodiment of FIG. 1.

FIG. 3 is a partial cross-sectional view of the fishing reel according to the embodiment of FIG. 1.

FIG. 4 is an enlarged view illustrating a structure in the vicinity of a gap between the reel frame and a spool flange in FIG. 3.

FIG. 5 is a partial cross-sectional view schematically illustrating a coating on the spool surface of the fishing reel according to the present embodiment.

### DETAILED DESCRIPTION OF THE DRAWINGS

Embodiments of the present invention will be described in detail. However, the present invention should not be understood as being limited to the following embodiments.

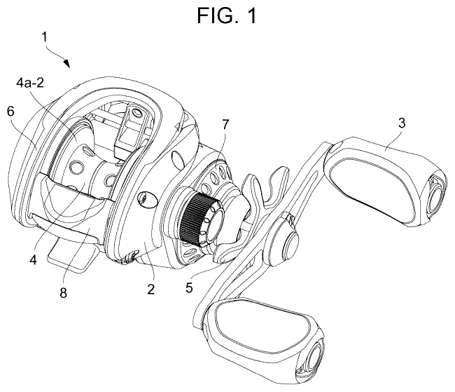

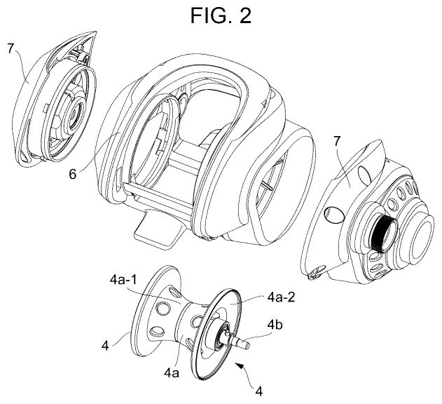

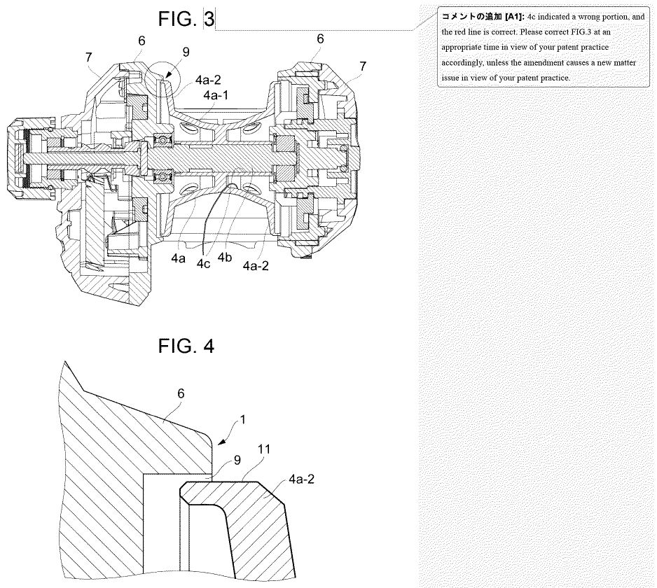

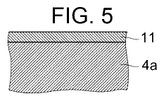

FIG. 1 illustrates a fishing reel according to one embodiment of the present invention. FIG. 2 illustrates a side plate, a reel frame and a spool assembly of the fishing reel according to this embodiment. FIG. 3 illustrates a partial sectional view of the fishing reel according to this embodiment. FIG. 4 is an enlarged view illustrating a structure in the vicinity of the gap between the reel frame and the spool flange set forth in FIG. 3. FIG. 5 is a partial cross-sectional view schematically illustrating a coating on the spool surface of the fishing reel according to this embodiment.

The fishing reel 1 is a double-bearing reel and is a low-profile reel for bait casting. As illustrated in FIGS. 1 to 3, the fishing reel 1 comprises a reel main body 2, a handle assembly 3 located on a side of the reel main body 2, and a spool assembly 4 for winding a line which is rotatably and detachably mounted inside the reel main body 2. A star drag 5 for drag adjustment is provided on the reel main body 2 side of the handle assembly 3.

The reel main body 2 comprises a reel frame 6, side plates 7 attached to both sides of the reel frame 6, and a front cover 8 covering the front of the reel frame 6.

A spool 4a is a magnesium alloy member, for example, obtained by injection molding by a die casting method. The spool 4a comprises a cylindrical spool arbor 4a-1 and a spool flange 4a-2 integrally formed on both side portions of the spool arbor 4a-1 and protruding outward. The spool 4a is non-rotatably fixed to a spool shaft 4b, which is constituted by a rod-like member, for example, made of stainless steel or aluminum alloy, for example, by serration coupling, to form the spool assembly 4. This fixing method is not limited to fixing methods enjoying unevenness, such as serration coupling, and various coupling methods such as adhesion and insert molding can be used.

In another embodiment, the spool assembly 4 comprises a spool shaft 4b, a spool 4a, and a sleeve (not illustrated) interposed between them, and the spool 4a is fixed to the spool shaft 4b via the sleeve (not illustrated). In the spool assembly 4, for example, the spool shaft 4b is made of stainless alloy or the like, and the sleeve (not illustrated) is made of aluminum alloy or the like.

The spool 4a is made of magnesium alloy, and as illustrated in FIGS. 4 and 5, a coating 11 is formed by a MAO treatment on a part of the spool 4a, including at least the spool flange 4a-2, preferably a part including at least the spool flange 4a-2 and the inner surface 4c of the spool arbor 4a-1, particularly preferably the entire surface thereof. The coating 11 formed by the MAO treatment varies depending on an electrolytic compound in an electrolytic bath used to form it, but can be constituted by an oxide such as MgO, MgAl₂O₄, MgSiO₃, Cu₃MgO₄, V₂O₅, V₂O₃, VAlO₄, or the like to completely shield the coated spool portion from the external environment. Further, the coating 11 is non-conductive and has very high hardness. Thus, the coating 11 can prevent corrosion of the spool 4a for a long period of time, and imparts excellent scratch resistance and UV weather resistance to the spool 4a.

A coating 11 formed by a MAO treatment can also be extremely thin and precisely controlled in thickness, typically being 1 μm to 50 μm in thickness, preferably 5 μm to about 40 μm, more preferably 10 μm to 30 μm, still more preferably 15 μm to 25 μm, and particularly preferably 17 μm to 23 μm in thickness. In addition, by keeping the treatment conditions constant, the thickness can be controlled in the range of usually ±5 μm, preferably ±3 μm. Thus, the size of the gap 10 between the reel frame 6 and the spool flange 4a-2, illustrated in FIG. 4, can be precisely controlled, and for example, the gap 10 can be set to a size capable of preventing a line from entering the gap 10 while ensuring smooth operation of the spool. The size of the gap 10 is usually 0.05 mm to 0.25 mm, preferably 0.10 mm to 0.20 mm, and more preferably 0.08 mm to 0.18 mm.

In a case where a spool assembly 4 is manufactured by directly bonding a spool 4a to a spool shaft 4b, even if the spool shaft 4b is made of, for example, aluminum alloy, stainless alloy, or the like, the spool 4a has a non-conductive coating 11 on the surface of the spool 4a, so that a local battery is not formed and no corrosion occurs when sea water enters the reel. In a preferred embodiment, a spool shaft 4b is made of anodized aluminum alloy. In this case, a non-conductive coating is formed on the surfaces of both the spool 4a and the spool shaft 4b, and the spool 4a and the spool shaft 4b are more reliably brought into a non-electrical contact state.

In a spool assembly 4 comprising a spool shaft 4b, a spool 4a, and a sleeve (not illustrated) interposed between them, wherein the spool 4a is fixed to the spool shaft 4b via the sleeve (not illustrated); for example, the spool shaft 4b is made of stainless alloy or the like, and the sleeve (not illustrated) is made of aluminum alloy or the like. Even in this case, the spool 4a has a non-conductive coating 11 on the surface thereof, and thus no local battery is formed through these members, and no corrosion occurs, even when sea water enters the reel. In a preferred embodiment, the sleeve is made of anodized aluminum alloy, whereby no local battery is formed and no corrosion occurs between the sleeve and the spool shaft, either.

In another embodiment, a spool shaft 4b and a sleeve (not illustrated) are both made of magnesium alloy, and have a coating 11 formed by a MAO treatment on the surfaces of the spool shaft 4b and the sleeve (not illustrated). The coating 11 makes the surface of each member completely non-conductive and reliably prevents corrosion.

A coating 11 formed by a MAO treatment can be formed by immersing the spool and, if necessary, other members such as a spool shaft 4b and a sleeve (not illustrated) in an electrolytic bath and then oxidizing Mg on the surface of the spool by microdischarge.

The electrolytic bath is usually an aqueous solution of an electrolytic compound in an amount of 5% by mass to 30% by mass, preferably 7% by mass to 18% by mass, more preferably 10% by mass to 15% by mass.

Examples of the electrolytic compound include a silicate, a hydroxide, a fluoride, a phosphate, an aluminate, and a combination thereof, which will be contained in a compound that forms a coating.

Examples of the silicate include sodium silicate (Na₂SiO₃), and examples of the alkali metal hydroxide include sodium hydroxide (NaOH). Examples of the fluoride include sodium fluoride (NaF), and examples of the phosphate include sodium phosphate (Na₃PO₄). Examples of the aluminate include sodium aluminum dioxide (NaAlO₂) and sodium tetrahydroxydoaluminate (Na[Al(OH)₄]). Among them, a silicate, a phosphate, or a combination thereof is preferable.

Microdischarge can be performed by applying a high voltage current to a spool immersed in an electrolytic bath to generate plasma on the surface of the spool. In this process, the spool immersed in the electrolytic bath serves as one electrode and the counter electrode is an electrode made of any inert metal immersed in the same electrolytic bath. The counter electrode can be, for example, a stainless steel electrode. A DC or AC voltage is applied between both electrodes. Generally, the voltage may be equal to or higher than about 200 V, preferably about 200 V to about 700 V, more preferably about 300 V to about 600 V, and even more preferably about 400 V to about 550 V. The temperature of the electrolytic bath is not particularly limited, but may be usually about 20° C. to about 40° C., and preferably about 25° C. to about 35° C. However, temperatures outside of these ranges may be used.

The MAO treatment time may be about 5 minutes to an hour, preferably 10 to 30 minutes, and more preferably 15 to 25 minutes.

In a preferred embodiment, a coating 11 formed by a MAO treatment constitutes an outer surface of the spool without any further layer. A coating 11 formed by a MAO treatment may have a different color depending on the type of a constituent oxide, and for example, by forming the coating with any one of the above-described oxides and a combination thereof, the coating can be black or white with a unique texture. The unique color provided by the coating 11 formed by such an MAO treatment can directly constitute the design of the reel, and the reel can have a unique texture.

Since a spool according to the present invention is made of magnesium alloy, the spool has high rigidity and can be thinned, enabling the reel to be more reduced in weight. From such characteristics, the spool is preferably applied to a low-profile reel, and makes it possible to design a low-profile reel that can easily cast even an extremely lightweight rig of about 3 g. However, the present invention is not limited to these embodiments, and can also be applied to spools of other fishing reels such as a lever drag type or an electric type double-bearing reel, a spinning reel, and a single-bearing reel.

### EXAMPLES

Hereinafter, the present invention will be described more specifically with reference to Examples, but the present invention is not limited thereto.

### 1. Manufacture of Spools

120 magnesium alloy spools having the following size were manufactured by cutting from a round bar material.
Spool flange diameter: 30 mm
Spool width: 25.5 mm

Next, each of the spools was immersed in an electrolytic solution containing sodium silicate (Na₂SiO₃) and sodium phosphate (Na₃PO₄) at a concentration of 15 to 20 mass % and having a pH adjusted to 9 to 13, and the MAO treatment was performed under the following conditions.
Voltage/current condition: constant current of 10 to 15 A/dm², voltage of 500 V to 550 V
Current supply manner: DC constant current
Frequency: 500 Hz
Duty ratio: 20%
Positive/negative current ratio: 3:1
Anodization time: 15 to 25 minutes in a recycle cooling device at 25° C.

After the treatment, the spool was cut, and the cut surface was observed with an electron microscope to confirm the thickness of the formed oxide coating. It was confirmed that the thicknesses of the coatings formed on the 120 spools were all 20±3 μm.

### 2. UV and Humidity Exposure Test

The MAO-coated spools obtained above were subjected to a UV weathering test. The test conditions are as follows.

### (Test Conditions)

The test was performed according to SAE J1960 standard. Specifically, the “Accelerated Exposure of Automotive Exterior Materials Using Controlled Irradiance Water-Cooled Xenon Arc Apparatus” was used to expose the spools manufactured as described above to ultraviolet rays at 14 levels from 33 KJ/m² to 1000 KJ/m² (33 KJ/m², 66 KJ/m², 100 KJ/m², 233 KJ/m², 300 KJ/m², 366 KJ/m², 500 KJ/m², 600 KJ/m², 700 KJ/m², 800 KJ/m², 833 KJ/m², 933 KJ/m², 966 KJ/m², and 1000 KJ/m²) f in the following cycle.

TABLE 1
SAE J1960 Test Cycle:

Expose to ultraviolet rays at 70° C. for 40 minutes
== > Expose to ultraviolet rays for 20 minutes
== > Spray with water at flow rate of 0.3 L/min
== > Expose to ultraviolet rays at 70° C. for 60 minutes
== > Leave in dark place for 60 minutes
== > Spray with water at flow rate 0.3 L/min

### (Evaluation)

The surface of the treated spool was observed with naked eyes to confirm whether there were discoloration, cracking, peeling, and blistering, and a spool that exhibited any of these was evaluated as x, and a spool that exhibited none of them was evaluated as ◯.

### (Test Results)

The spools subjected to the respective tests with different levels of ultraviolet rays were evaluated as follows.

TABLE 2

| Amount of ultraviolet rays | Evaluation |
|---|---|
| 33 KJ/m² | ◯ |
| 66 KJ/m² | ◯ |
| 100 KJ/m² | ◯ |
| 23 KJ/m² | ◯ |
| 300 KJ/m² | ◯ |
| 366 KJ/m² | ◯ |
| 500 KJ/m² | ◯ |
| 600 KJ/m² | ◯ |
| 700 KJ/m² | X |
| 800 KJ/m² | X |
| 833 KJ/m² | X |
| 933 KJ/m² | X |
| 966 KJ/m² | X |
| 1000 KJ/m² | X |

It is known that discoloration is observed at about 500 KJ/m² in the spool treated with alumite. On the other hand, the spools having the coatings formed by the MAO treatments exhibited no discoloration, cracking, peeling, or blistering up to 600 KJ, indicating higher UV weather resistance.

### REFERENCE SIGNS LIST

1 Fishing reel
2 Reel main body
3 Handle assembly
4 Spool assembly
4a Spool
4a-1 Spool arbor
4a-2 Spool flange
4b Spool shaft
5 Star drag
6 Reel frame
7 Side plate
8 Front cover
9 Sleeve
10 Gap
11 Coating formed by MAO treatment

1. A magnesium alloy spool comprising a coating formed by a micro-arc oxidation (MAO) treatment on the surface of a portion including at least a spool flange.

2. The spool according to claim 1, further comprising a coating formed by a micro-arc oxidation (MAO) treatment on the surface of a portion including the inner surface of a spool arbor of the spool.

3. The spool according to claim 1, comprising a coating formed by a micro-arc oxidation (MAO) treatment on the entire surface of the spool.

4. The spool according to claim 1, wherein a thickness of the coating is in the range of 20±3 μm.

5. A spool assembly, wherein the spool according to claim 1 is attached to a spool shaft directly or via a sleeve.

6. The spool assembly according to claim 5, wherein the spool shaft is made of anodized aluminum alloy.

7. A spool assembly comprising:
the spool according to claim 1;
a spool shaft; and
a sleeve interposed between the spool and the spool shaft,
wherein the spool is attached to the spool shaft via a sleeve.

8. The spool assembly according to claim 5, wherein the sleeve and/or the spool shaft are made of anodized aluminum alloy.

9. A fishing reel comprising the spool according claim 1.

10. The fishing reel according to claim 9, wherein a gap between the reel frame and a flange of the spool is in the range of 0.08 mm to 0.18 mm.

11. A fishing reel comprising:
the spool assembly according to claim 5.

12. The fishing reel according to claim 11, wherein a gap between the reel frame and a flange of the spool is in the range of 0.08 mm to 0.18 mm.
